(19) United States
(12) Patent Application Publication
(10) Pub. No.: US 2011/0271698 A1
(43) Pub. Date: Nov. 10, 2011

(54) Method Of Controlling A Compressor In An Air-Conditioning System

(75) Inventors: Bradley C. Errington, Bellefontaine, OH (US); Trevor Burns, Milford Center, OH (US)

(73) Assignee: Honda Motor Co., Ltd., Tokyo (JP)

(21) Appl. No.: 12/773,258

(22) Filed: May 4, 2010

(51) Int. Cl. F25B 49/02; B60H 1/32

(52) U.S. Cl. 62/227; 62/226; 165/202

(57) ABSTRACT

A method of controlling an air-conditioning system for a motor vehicle is disclosed. The method includes provisions for controlling a compressor to achieve a desired evaporator temperature. The method includes a step of selecting a gain parameter and a reset parameter according to the ambient temperature for use in a set of proportional-integral calculations.

### BACKGROUND

The present invention relates generally to a motor vehicle, and in particular to an air-conditioning system for a motor vehicle.

Air-conditioning systems for motor vehicles have been previously proposed. Previous designs have used variable displacement compressors to control an evaporator temperature for purposes of cooling air in a motor vehicle. However, these systems do not consider ambient conditions in determining how to control a compressor. There is a need in the art for a design that overcomes the limitations of the related art.

### SUMMARY

In one aspect, the invention provides a method of controlling an air-conditioning system in a motor vehicle, including the steps of: receiving information related to an actual evaporator temperature; receiving information related to a desired evaporator temperature; calculating an evaporator temperature error from the actual evaporator temperature and the desired evaporator temperature; receiving information related to an ambient temperature; calculating a compressor stroke correction value using the evaporator temperature and the ambient temperature; and controlling the compressor using the compressor stroke correction value.

In another aspect, the invention provides a method of controlling an air-conditioning system in a motor vehicle, including the steps of: receiving information related to an actual evaporator temperature; receiving information related to a desired evaporator temperature; calculating an evaporator temperature error from the actual evaporator temperature and the desired evaporator temperature; receiving information related to an ambient temperature; retrieving a threshold temperature; and calculating a compressor stroke correction value using a control parameter and the evaporator temperature error. The control parameter is associated with a proportional-integral control algorithm. The control parameter has a first value when the ambient temperature is above the threshold temperature and the control parameter has a second value when the ambient temperature is below the threshold temperature. The first value for the control parameter is different from the second value.

In another aspect, the invention provides a method of controlling an air-conditioning system in a motor vehicle, including the steps of: receiving information related to an actual evaporator temperature; receiving information related to a desired evaporator temperature; calculating an evaporator temperature error from the actual evaporator temperature and the desired evaporator temperature; receiving information related to an ambient temperature; retrieving a threshold temperature; and operating a compressor in a first compressor stroke range when the ambient temperature is above the threshold temperature and operating the compressor in a second compressor stroke range when the ambient temperature is below the threshold temperature. The first compressor stroke range is different from the second compressor stroke range.

Other systems, methods, features and advantages of the invention will be, or will become, apparent to one of ordinary skill in the art upon examination of the following figures and detailed description. It is intended that all such additional systems, methods, features and advantages be included within this description and this summary, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1 is a schematic view of an embodiment of a motor vehicle with an air-conditioning system;

FIG. 2 is a schematic view of an embodiment of a relationship between a compressor stroke and an evaporator temperature in an air-conditioning system;

FIG. 3 is an embodiment of a process for controlling an air-conditioning system;

FIG. 4 is a schematic view of an embodiment of a relationship between a compressor stroke and an evaporator temperature in an air-conditioning system;

FIG. 5 is a schematic view of an embodiment of a relationship between a compressor stroke and an evaporator temperature in an air-conditioning system;

FIG. 6 is a schematic view of an embodiment of a calculation unit for an air-conditioning system;

FIG. 7 is a schematic view of an embodiment of a calculation unit for an air-conditioning system;

FIG. 8 is a schematic view of an embodiment of a relationship between ambient temperature and a gain parameter;

FIG. 9 is a schematic view of an embodiment of a relationship between ambient temperature and a reset parameter;

FIG. 10 is an embodiment of a process of controlling an air-conditioning system;

FIG. 11 is an embodiment of a process of controlling an air-conditioning system; and

FIG. 12 is an embodiment of a process of controlling an air-conditioning system.

### DETAILED DESCRIPTION

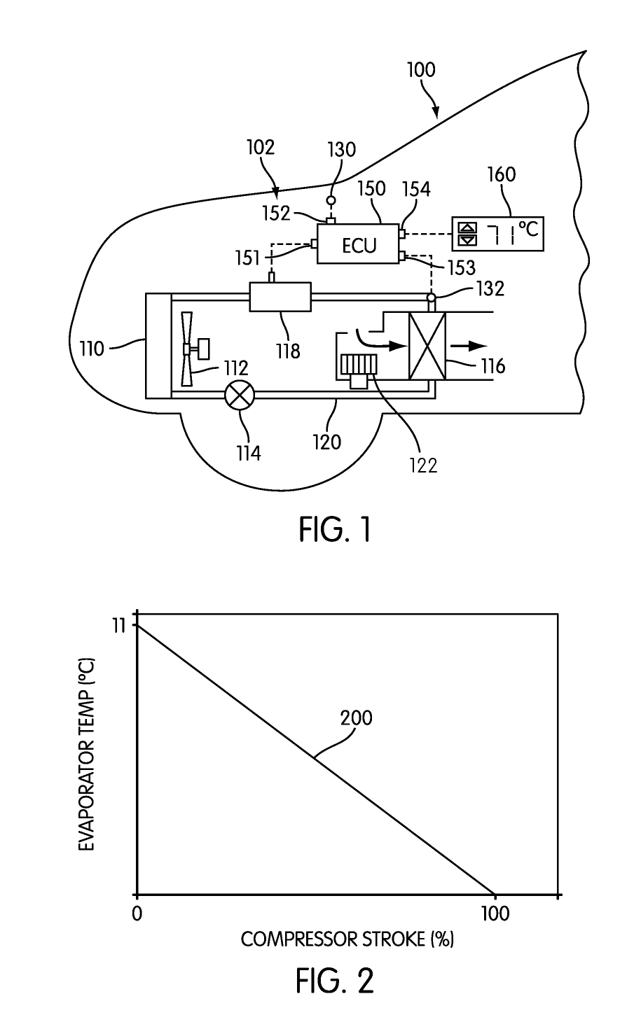

FIG. 1 is a schematic view of an embodiment of motor vehicle 100. The term “motor vehicle” as used throughout the specification and claims refers to any moving vehicle that is capable of carrying one or more human occupants and is powered by any form of energy. The term “motor vehicle” includes, but is not limited to: cars, trucks, vans, minivans, SUVs, motorcycles, scooters, boats, personal watercraft, and aircraft.

In some cases, the motor vehicle includes one or more engines. The term “engine” as used throughout the specification and claims refers to any device or machine that is capable of converting energy. In some cases, potential energy is converted to kinetic energy. For example, energy conversion can include a situation where the chemical potential energy of a fuel or fuel cell is converted into rotational kinetic energy or where electrical potential energy is converted into rotational kinetic energy. Engines can also include provisions for converting kinetic energy into potential energy. For example, some engines include regenerative braking systems where kinetic energy from a drivetrain is converted into potential energy. Engines can also include devices that convert solar or nuclear energy into another form of energy. Some examples of engines include, but are not limited to: internal combustion engines, electric motors, solar energy converters, turbines, nuclear power plants, and hybrid systems that combine two or more different types of energy conversion processes.

Motor vehicle 100 can include air-conditioning system 102. Generally, air-conditioning system 102 can be disposed in any portion of motor vehicle 100. In some cases, air-conditioning system 102 can be disposed in a front portion of motor vehicle 100. In other cases, air-conditioning system 102 can be disposed in a rear portion of motor vehicle 100. In still other cases, air-conditioning system 102 can be disposed in any other portion of motor vehicle 100. In an exemplary embodiment, air-conditioning system 102 may be disposed in a front portion of motor vehicle 100 that is adjacent to an engine of motor vehicle 100.

In some embodiments, air-conditioning system 102 may comprise condenser 110 and condenser fan 112. In addition, air-conditioning system 102 may further comprise expansion valve 114, evaporator 116 and compressor 118. In one embodiment, condenser 110, expansion valve 114, evaporator 116 and compressor 118 may be connected by tubing 120. In some cases, tubing 120 may be refrigerant tubing that is configured to transfer one or more refrigerants between each component in a refrigeration cycle.

Each of these components for an air-conditioning system are known in the art. In different embodiments, various types of compressors, evaporators, condensers and expansion valves could be used. As an example, compressor 118 can be any type of compressor. In some cases, compressor 118 may be a variable displacement type compressor. Examples of variable-displacement compressors can be found in U.S. Pat. Nos. 5,148,685; 5,014,522; and 4,934,157, the entirety of each being hereby incorporated by reference. By using a variable displacement type compressor, the operating of air-conditioning system 102 can be modified to control the temperature of a refrigerant at various locations throughout the system.

Generally, air-conditioning system 102 may operate in a manner configured to provide cooled air to passengers of motor vehicle 100. Compressor 118 may work to compress gas refrigerant that has been vaporized at evaporator 116. In particular, the gas refrigerant may be in a low temperature and low pressure state upon leaving evaporator 116. Compressor 118 works to compress the gas refrigerant so that the gas refrigerant has a high temperature and a high pressure upon leaving compressor 118. Upon leaving compressor 118, the gas refrigerant is transferred to condenser 110, which condenses the gas refrigerant, thereby turning the gas refrigerant to a liquid refrigerant. At this point, the liquid refrigerant is transferred to expansion valve 114 where the liquid refrigerant is depressurized and expands the liquid refrigerant into a spray refrigerant. The refrigerant is then delivered to evaporator 116 to remove heat from inlet air that flows from blower fan 122 in order to cool the inlet air.

Motor vehicle 100 can include one or more sensors for detecting the conditions of various systems or components of motor vehicle 100. Examples of conditions include, but are not limited to: the temperature of one or more components, the pressure of one or more components, the operating state of one or more components as well as other conditions. Motor vehicle 100 can also include one or more sensors for detecting ambient conditions associated with a motor vehicle. Examples of ambient conditions that could be detected using one or more sensors include, but are not limited to: temperature, pressure, humidity, as well as other conditions. In an exemplary embodiment, motor vehicle 100 can include ambient temperature sensor 130 and evaporator temperature sensor 132. Ambient temperature sensor 130 may be capable of receiving information related to the ambient temperature of a motor vehicle. Evaporator temperature sensor 132 may be capable of receiving information related to the temperature of evaporator 116.

In different embodiments, the locations of ambient temperature sensor 130 and evaporator temperature sensor 132 may vary. In some cases, ambient temperature sensor 130 may be disposed adjacent to air-conditioning system 102. In other cases, ambient temperature sensor 130 may be disposed in any other portion of motor vehicle 100. In addition, in some cases, evaporator temperature sensor 132 may be disposed adjacent to evaporator 116. In other cases, evaporator temperature sensor 132 may be disposed within a portion of evaporator 116. In still other cases, evaporator temperature sensor 132 may be disposed in a portion of tubing 120 that is disposed downstream of evaporator 116.

Motor vehicle 100 may include provisions for communicating, and in some cases controlling, the various components associated with air-conditioning system 102. In some embodiments, motor vehicle 100 may be associated with a computer or similar device. In the current embodiment, motor vehicle 100 may be associated with an electronic control unit, hereby referred to as ECU 150.

ECU 150 may include a number of ports that facilitate the input and output of information and power. The term “port” as used throughout this detailed description and in the claims refers to any interface or shared boundary between two conductors. In some cases, ports can facilitate the insertion and removal of conductors. Examples of these types of ports include mechanical connectors. In other cases, ports are interfaces that generally do not provide easy insertion or removal. Examples of these types of ports include soldering or electron traces on circuit boards.

All of the following ports and provisions associated with ECU 150 are optional. Some embodiments may include a given port or provision, while others may exclude it. The following description discloses many of the possible ports and provisions that can be used, however, it should be kept in mind that not every port or provision must be used or included in a given embodiment.

In some embodiments, ECU 150 can include port 151 for communicating with compressor 118. In one embodiment, ECU 150 may transmit control signals to compressor 118 for controlling a compressor stroke of compressor 118 via port 151. In some cases, ECU 150 may also receive information from compressor 118 via port 151.

ECU 150 may be configured to receive information from one or more sensors associated with motor vehicle 100, including sensors specifically associated with air-conditioning system 102. In one embodiment, ECU 150 may include port 152 for receiving information from ambient temperature sensor 130. Also, in one embodiment, ECU 150 may include port 153 for receiving information from evaporator temperature sensor 132.

In other embodiments, ECU 150 can include provisions for communicating with any other components of motor vehicle 100, including air-conditioning system 102. In another embodiment, ECU 150 could include ports for communicating with expansion valve 114, blower fan 122, condenser fan 112 and evaporator 116, as well as any other components of air-conditioning system 102. In still other embodiments, ECU 120 could include provisions for communicating with any other components and/or systems of motor vehicle 100.

Air-conditioning system 102 can include provisions for receiving user input. In one embodiment, air-conditioning system 102 can include user interface 160. In this case, user interface 160 may comprise one or more buttons, dials or other provisions that allow a user to set the desired temperature. As an example, user interface 160 of the present embodiment illustrates a digital interface that allows a user to select a preset temperature. In other cases, however, a user may not be able to set a temperature, and instead a user may only operate an air-conditioner in a range of values associated with various levels of cooling. For example, in some other embodiments, a user interface could comprise a dial with discrete settings between no cooling and maximum cooling. In an exemplary embodiment, ECU 150 can include port 154 for communicating with user interface 160.

For purposes of providing cooled air at a preset temperature, air-conditioning system 102 may include provisions for controlling the evaporator temperature at evaporator 116. In some embodiments, the operation of one or more components of air-conditioning system 102 can be changed to adjust the evaporator temperature. In embodiments including a variable compression type compressor, the compressor stroke of compressor 118 can be adjusted to control the evaporator temperature.

FIG. 2 illustrates an embodiment of a relationship between the evaporator temperature and the compressor stroke in an air-conditioning system. Referring to FIG. 2, the evaporator temperature is given in units of degrees Celsius and the compressor stroke is given as a percentage of one full stroke. As illustrated in this embodiment, as the length of the compressor stroke is increased, the evaporator temperature of the refrigerant near evaporator 116 is reduced in a substantially linear manner. For example, with no compression occurring (0 percent) the evaporator temperature has a maximum value of 11 degrees Celsius. In contrast, when the compressor stroke is at maximum (100 percent) the evaporator temperature has a minimum value of 0 degrees Celsius. Moreover, as the length of the compressor stroke is varied between no compressor stroke and full compressor stroke, the evaporator temperature varies in the range between 0 and 11 degrees Celsius, as indicated by relationship 200. With this arrangement, an air-conditioning system can be configured to control the evaporator temperature by varying the compressor stroke in order to adjust the temperature of air cooled by the air-conditioning system. By varying the evaporator temperature, the temperature of the air cooled by the air-conditioning system can be adjusted.

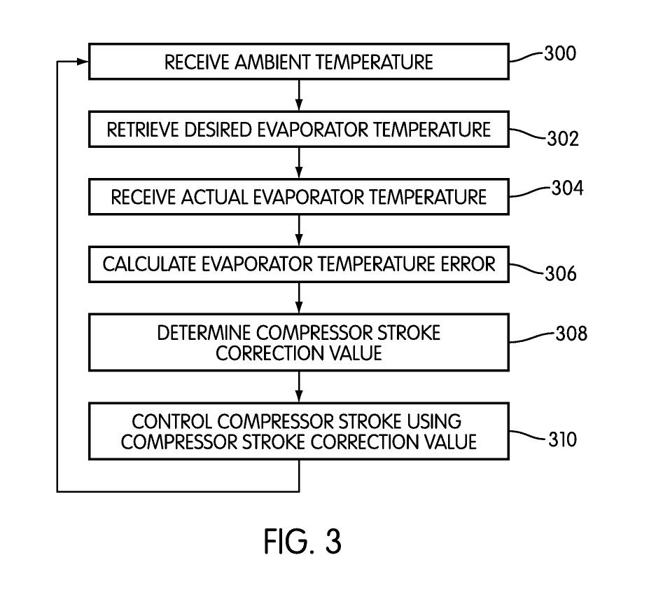

FIG. 3 illustrates an embodiment of a process for controlling an air-conditioning system. In this embodiment, the following steps may be performed by various subsystems of a motor vehicle. For example, in some cases, the following steps could be performed by ECU 150. However, in some other embodiments these steps may be performed by additional systems or devices associated with motor vehicle 100. In addition, it will be understood that in other embodiments one or more of the following steps may be optional.

During step 300, ECU 150 may receive an ambient temperature or information related to an ambient temperature. As discussed above, ECU 150 could receive an ambient temperature or information related to an ambient temperature from ambient temperature sensor 130. Next, ECU 150 may proceed to step 302. During step 302, ECU 150 may retrieve a desired evaporator temperature. In some cases, the desired evaporator temperature could be directly related to a user selected temperature that may be received through a user interface. It will be understood that the desired evaporator temperature is not necessarily equivalent to the user selected temperature since the desired evaporator temperature is associated with the temperature of the refrigerant, while the user selected temperature is associated with the air temperature inside the cabin of the motor vehicle. Instead, in some cases, the desired evaporator temperature may be proportional to the user selected temperature. For example, as the user selected temperature is decreased, the desired evaporator temperature may also decrease in a proportional manner. In one embodiment, ECU 150 may include an algorithm for determining the desired evaporator temperature according to the user selected temperature. Moreover, it will be understood that in still other embodiments, the relationship between the desired evaporator temperature and the user selected temperature may vary with the ambient conditions such as the ambient temperature and/or the ambient pressure as well as other parameters.

Following step 302, during step 304, ECU 150 may receive information related to the actual evaporator temperature. In one embodiment, ECU 150 may receive information from evaporator temperature sensor 132. Using the information received from evaporator temperature sensor 132, ECU 150 may determine the actual evaporator temperature. Next, during step 306, ECU 150 may calculate the evaporator temperature error, which is the difference between the desired evaporator temperature and the actual evaporator temperature. In some cases, this value could be calculated as the desired evaporator temperature minus the actual evaporator temperature. In other cases, this value could be calculated as the actual evaporator temperature minus the desired evaporator temperature. In still other cases, other calculations could be used for determining the evaporator temperature error.

After step 306, ECU 150 may proceed to step 308. During step 308, ECU 150 may determine how much to change the compressor stroke to reduce the evaporator temperature error. In other words, during step 308 ECU 150 may determine how much to change the compressor stroke so that the actual evaporator temperature approaches the desired evaporator temperature. In one embodiment, ECU 150 may determine a compressor stroke correction value. In some cases, the compressor stroke correction value can be associated with a physical parameter that characterizes the compression stroke. For example, in embodiments where the compressor stroke is associated with a length in centimeters, the compressor stroke correction value may be given as a length in centimeters. In other cases, the compressor stroke correction value can be associated with an intermediate parameter used to control the compressor stroke. For example, in embodiments where the length of the compressor stroke is controlled according to an electric current sent from ECU 150 to compressor 118, the compressor stroke correction value can be given as an electric current in amperes.

In some cases, the compressor stroke correction value may be the sum of the current compressor stroke value and an adjustment value. In other cases, however, the compressor stroke correction value may not include the current compressor stroke. In these cases, the compressor stroke correction value may be added to the current compressor stroke value to obtain a new compressor stroke value.

Following step 308, ECU 150 may proceed to step 310. During step 310, ECU 150 may control the compressor stroke using the compressor stroke correction value. In other words, using the compressor stroke correction value, ECU 150 may adjust the signal sent to compressor 118 in order to change the compressor stroke. Following step 310, ECU 150 may return to step 300. It will be understood that this process may continue indefinitely as ECU 150 attempts to reduce the error between the desired evaporator temperature and the actual evaporator temperature. In other words, this process may comprise a feedback control loop that is continually adjusted as long as the desired evaporator temperature and the actual evaporator temperature are not equal.

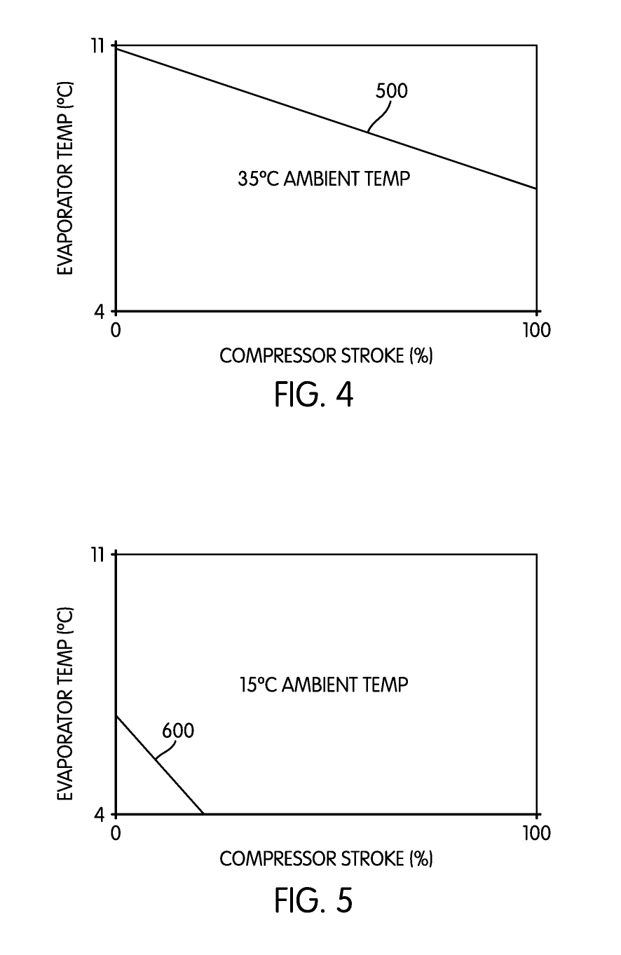

FIGS. 4 and 5 illustrate embodiments of relationships of air-conditioning system characteristics for different ambient temperatures. In particular, FIG. 4 illustrates an embodiment of relationship 500 between a compressor stroke and an evaporator temperature for an ambient temperature of 35 degrees Celsius, while FIG. 5 illustrates an embodiment of relationship 600 between a compressor stroke and an evaporator temperature for an ambient temperature of 15 degrees Celsius. Referring to FIGS. 4 and 5, the relationship between the compressor stroke and the evaporator temperature varies for the two different ambient temperatures shown. In other words, as the ambient temperature varies, the amount of compression required by a compressor to achieve a particular evaporator temperature will vary. Therefore, in some cases, a method of controlling an air-conditioning system can include provisions for modifying the way in which the compressor stoke is controlled as the ambient temperature changes.

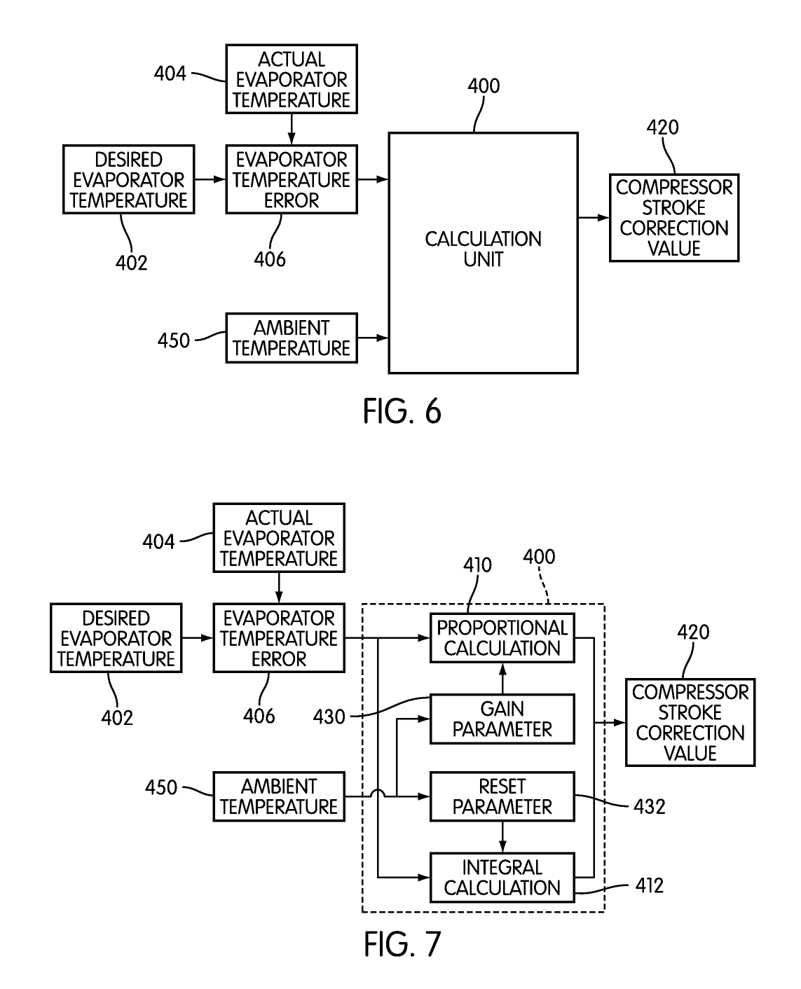

FIG. 6 illustrates an embodiment of a calculation unit that is capable of calculating compressor stroke correction value 420. In this embodiment, desired evaporator temperature 402 and actual evaporator temperature 404 are used to determine evaporator temperature error 406, as discussed above. In this case, evaporator temperature error 406 may be an input to calculation unit 400. In addition, ambient temperature 450 may also be an input to calculation unit 400. With this arrangement, the value of compressor stroke correction value 420 may vary with both the evaporator temperature error, as well as with the ambient temperature. This provides for a method of controlling the compressor stroke to accommodate for variations in the response of the evaporator temperature in varying ambient temperature conditions.

In one embodiment, calculation unit 400 may be associated with any algorithms for determining a compressor stroke correction value. In some embodiments, calculation unit 400 may be associated with proportional-integral type calculations that are used in a proportional-integral controller. In other embodiments, calculation unit 400 may be associated with proportional-integral-derivative calculations that are used in proportional-integral-derivative (PID) controllers. In other embodiments, calculation unit 400 can comprise any other type of calculations including any type of known control feedback mechanism.

Referring to FIG. 7, in an exemplary embodiment, calculation unit 400 may comprise a proportional-integral type calculation unit. In one embodiment, calculation unit 400 can comprise proportional calculation 410 and integral calculation 412. In some cases, a proportional calculation may be a calculation that is used to change the compressor stroke correction value in a manner that is proportional to the evaporator temperature error. Likewise, in some cases, an integral calculation may be a calculation that is used to change the compressor stroke correction value in a manner that is proportional to both the magnitude of the evaporator temperature error and the duration of the error. Algorithms for proportional calculations and integral calculations associated with a proportional-integral controller are known in the art.

In some embodiments, proportional calculation 410 and integral calculation 412 may require one or more control parameters. For example, in one embodiment, proportional calculation 410 may receive gain parameter 430 as an input. Also, in one embodiment, integral calculation 412 may receive reset parameter 432 as an input. In some embodiments, gain parameter 430 and reset parameter 432 may be constants values. In other embodiments, gain parameter 430 and reset parameter 432 may be parameters that vary according to various operating parameters and/or ambient conditions of a motor vehicle.

In some embodiments, a calculation unit can include provisions for adjusting a gain parameter and/or a reset parameter according to ambient temperature. In some cases, the gain parameter and/or the reset parameter can vary in a continuous manner as a function of the ambient temperature. In other cases, the gain parameter and/or the reset parameter can vary in a discrete manner according to the ambient temperature. For example, in one embodiment, the gain parameter can vary between a first value and a second value according to a threshold temperature. Likewise, in one embodiment, the reset parameter can vary between a first value and a second value according to a threshold temperature.

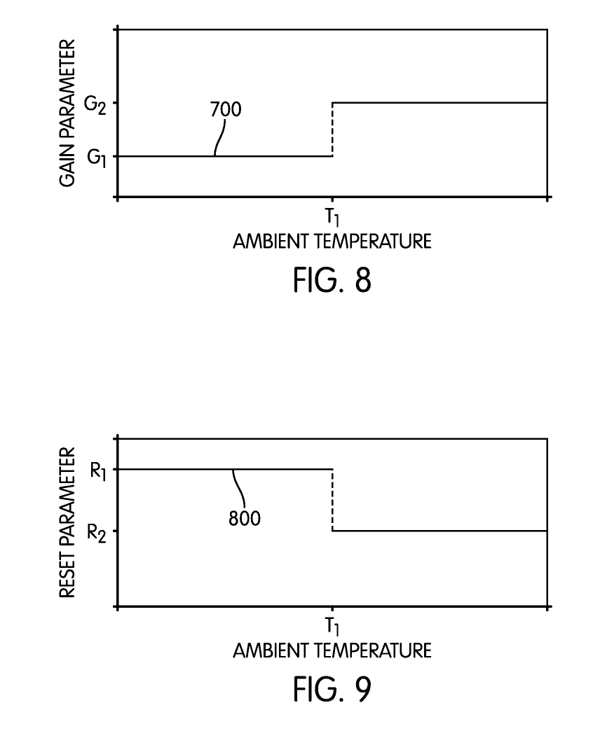

FIG. 8 illustrates an exemplary embodiment of a relationship between ambient temperature and a gain parameter for a proportional calculation. Referring to FIG. 8, in some embodiment, the gain parameter may vary between two fixed values. In this case, gain parameter 700 has first gain value G1 whenever the ambient temperature is less than threshold temperature T1. In addition, gain parameter 700 has second gain value G2 whenever the ambient temperature is greater than or equal to threshold temperature T1. In this example, first gain value G1 may be substantially less than second gain value G2. In other embodiments, however, first gain value G1 could be substantially greater than second gain value G2. In still other embodiments, first gain value G1 could be approximately equal to second gain value G2. With this arrangement, the proportional calculations used to determine a compressor stroke correction value can be tuned to the current ambient temperature.

FIG. 9 illustrates an exemplary embodiment of a relationship between ambient temperature and a reset parameter for an integral calculation. Referring to FIG. 9, in some embodiment, the reset parameter may vary between two fixed values. In this case, reset parameter 800 has first reset value R1 whenever the ambient temperature is less than threshold temperature T1. In addition, reset parameter 800 has second reset value R2 whenever the ambient temperature is greater than or equal to threshold temperature T1. In this example, first reset value R1 may be substantially larger than second reset value R2. In other embodiments, however, first reset value R1 could be substantially less than second reset value R2. In still other embodiments, first reset value R1 could be approximately equal to second reset value R2. With this arrangement, the integral calculations used to determine a compressor stroke correction value can be tuned to the current ambient temperature.

Generally, temperature threshold T1 can have any value. In some cases, temperature threshold T1 can vary in the range between 0 degrees Celsius and 100 degrees Celsius. In other embodiments, temperature threshold T1 can vary in the range between 15 degrees Celsius and 30 degrees Celsius. In one exemplary embodiment, temperature threshold T1 can have a value of approximately 22 degrees Celsius.

Although a single temperature threshold is discussed in the current embodiment, other embodiments can incorporate two or more temperature thresholds. For example, in another embodiment, a gain parameter and/or a reset parameter may have three possible values corresponding to ambient temperatures below a first threshold, above a second threshold and between the first threshold and the second threshold. In addition, while the current embodiment uses a single temperature threshold for determining both a gain parameter and a reset parameter, in other embodiments, a gain parameter can be selected according to a first temperature threshold and a reset parameter can be selected according to a second temperature threshold that is different from the first temperature threshold.

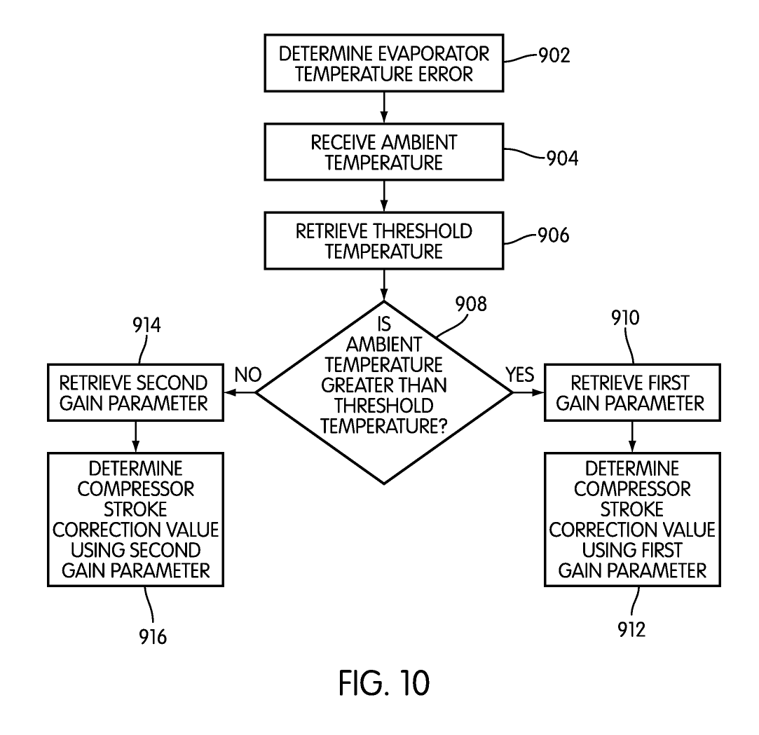

FIG. 10 illustrates an embodiment of a process for determining a compressor stroke correction value. In this embodiment, the following steps may be performed by various subsystems of a motor vehicle. For example, in some cases, the following steps could be performed by ECU 150. However, in some other embodiments these steps may be performed by additional systems or devices associated with motor vehicle 100. In addition, it will be understood that in other embodiments one or more of the following steps may be optional.

During step 902, ECU 150 may receive an evaporator temperature error. As discussed above, this may comprise additional steps of receiving information related to a desired evaporator temperature as well as an actual desired evaporator temperature and calculating the evaporator temperature error from these values. Next, during step 904, ECU 150 may receive an ambient temperature or information related to an ambient temperature. In some cases, ECU 150 may receive information from an ambient temperature sensor. In other cases, ECU 150 could receive information from any other system or component of a motor vehicle that is capable of receiving information related to an ambient temperature.

Following step 904, ECU 150 may proceed to step 906. During step 906, ECU 150 may retrieve a threshold temperature. In some cases, the threshold temperature can be a stored value. In other cases, the threshold temperature can be a value that is calculated according to various operating conditions and/or ambient conditions.

Following step 906, during step 908, ECU 150 may determine if the ambient temperature is greater than the threshold temperature. If so, ECU 150 may proceed to step 910. During step 910, ECU 150 may retrieve a first gain parameter that is stored in memory. Following step 910, ECU 150 may proceed to step 912 to determine the compressor stroke correction value using the first gain parameter. Specifically, in some cases, ECU 150 may perform a proportional calculation using the first gain parameter to determine a proportional part of the compressor stroke correction value. If, during step 908, ECU 150 determines that the ambient temperature is not greater than the threshold temperature, ECU 150 may proceed to step 914. During step 914, ECU 150 may retrieve a second gain parameter from memory. Following this, during step 916, ECU 150 may determine the compressor stroke correction value using the second gain parameter. Specifically, in some cases, ECU 150 may perform a proportional calculation using the second gain parameter to determine a proportional part of the compressor stroke correction value.

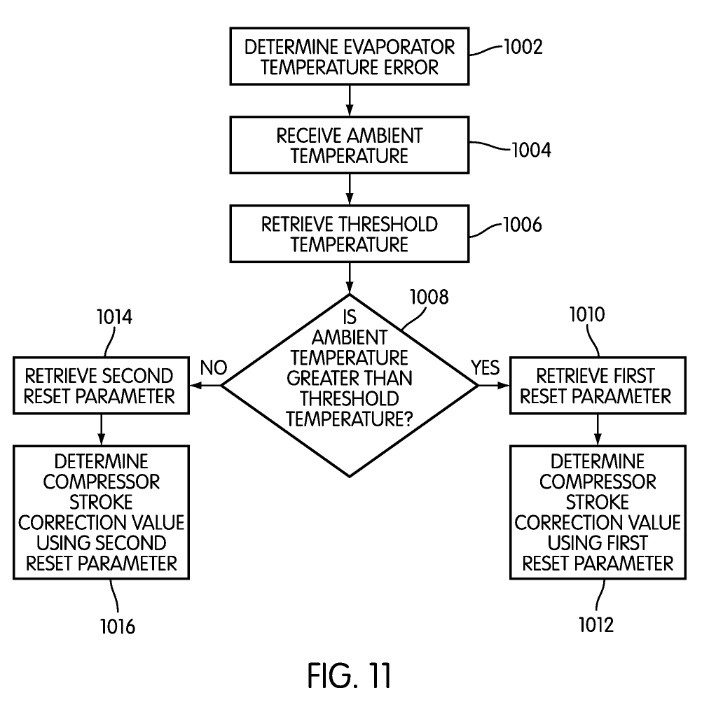

FIG. 11 illustrates an embodiment of a process for determining a compressor stroke correction value. In this embodiment, the following steps may be performed by various subsystems of a motor vehicle. For example, in some cases, the following steps could be performed by ECU 150. However, in some other embodiments these steps may be performed by additional systems or devices associated with motor vehicle 100. In addition, it will be understood that in other embodiments one or more of the following steps may be optional.

During step 1002, ECU 150 may receive an evaporator temperature error. As discussed above, this may comprise additional steps of receiving information related to a desired evaporator temperature as well as an actual desired evaporator temperature and calculating the evaporator temperature error from these values. Next, during step 1004, ECU 150 may receive an ambient temperature or information related to an ambient temperature. In some cases, ECU 150 may receive information from an ambient temperature sensor. In other cases, ECU 150 could receive information from any other system or component of a motor vehicle that is capable of receiving information related to an ambient temperature.

Following step 1004, ECU 150 may proceed to step 1006. During step 1006, ECU 150 may retrieve a threshold temperature. In some cases, the threshold temperature can be a stored value. In other cases, the threshold temperature can be a value that is calculated according to various operating conditions and/or ambient conditions.

Following step 1006, during step 1008, ECU 150 may determine if the ambient temperature is greater than the threshold temperature. If so, ECU 150 may proceed to step 1010. During step 1010, ECU 150 may retrieve a first reset parameter that is stored in memory. Following step 1010, ECU 150 may proceed to step 1012 to determine the compressor stroke correction value using the first reset parameter. Specifically, in some cases, ECU 150 may perform an integral calculation using the first reset parameter to determine an integral part of the compressor stroke correction value. If, during step 1008, ECU 150 determines that the ambient temperature is not greater than the threshold temperature, ECU 150 may proceed to step 1014. During step 1014, ECU 150 may retrieve a second reset parameter from memory. Following this, during step 1016, ECU 150 may determine the compressor stroke correction value using the second reset parameter. Specifically, in some cases, ECU 150 may perform an integral calculation using the second reset parameter to determine an integral part of the compressor stroke correction value.

In an exemplary embodiment, both processes illustrated in FIGS. 10 and 11 may be performed simultaneously to determine the compressor stroke correction value. In particular, the results of the proportional calculation and the integral calculation can be combined to give the compressor stroke correction value. In some cases, the values of the proportion calculation and the integral calculation can be summed. In other cases, these values can be combined in other ways to yield a compressor stroke correction value.

In some embodiments, by adjusting one or more parameters used to calculate a compressor stroke correction value according to the ambient temperature, the operational range of a compressor stroke may be changed. In other words, by varying a gain parameter and/or a reset parameter according to the ambient temperature, the operational range of a compressor stroke may be changed. Referring back to FIGS. 4 and 5, when an ambient temperature is above 22 degrees Celsius, the operational range of the compressor stroke may be a wide compressor stroke range to achieve various evaporator temperatures. In contrast, when an ambient temperature is below 22 degrees Celsius, the operational range of the compressor stroke may be a substantially narrow range to achieve various evaporator temperatures.

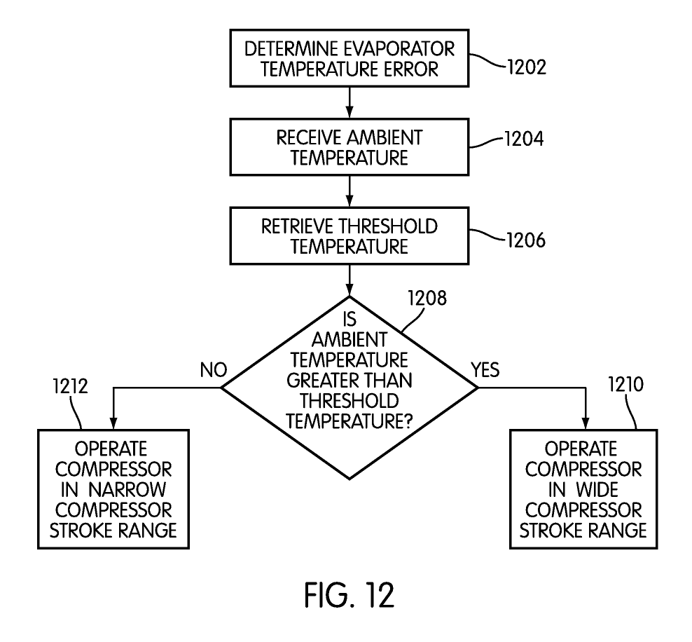

FIG. 12 illustrates an embodiment of a process for controlling an air-conditioning system. In this embodiment, the following steps may be performed by various subsystems of a motor vehicle. For example, in some cases, the following steps could be performed by ECU 150. However, in some other embodiments these steps may be performed by additional systems or devices associated with motor vehicle 100. In addition, it will be understood that in other embodiments one or more of the following steps may be optional.

During step 1202, ECU 150 may receive an evaporator temperature error. As discussed above, this may comprise additional steps of receiving information related to a desired evaporator temperature as well as an actual desired evaporator temperature and calculating the evaporator temperature error from these values. Next, during step 1204, ECU 150 may receive an ambient temperature or information related to an ambient temperature. In some cases, ECU 150 may receive information from an ambient temperature sensor. In other cases, ECU 150 could receive information from any other system or component of a motor vehicle that is capable of receiving information related to an ambient temperature.

Following step 1204, ECU 150 may proceed to step 1206. During step 1206, ECU 150 may retrieve a threshold temperature. In some cases, the threshold temperature can be a stored value. In other cases, the threshold temperature can be a value that is calculated according to various operating conditions and/or ambient conditions.

Following step 1206, during step 1208, ECU 150 may determine if the ambient temperature is greater than the threshold temperature. If so, ECU 150 may proceed to step 1210. During step 1210, ECU 150 may operate the compressor in a wide compressor stroke range. Otherwise, if during step 1208 ECU 150 determines that the ambient temperature is less than the threshold temperature, ECU 150 may operate the compressor in a narrow compressor stroke range during step 1212. With this arrangement, the operational range of a compressor can be varied according to the ambient temperature to more effectively control the evaporator temperature.

While various embodiments of the invention have been described, the description is intended to be exemplary, rather than limiting and it will be apparent to those of ordinary skill in the art that many more embodiments and implementations are possible that are within the scope of the invention. Accordingly, the invention is not to be restricted except in light of the attached claims and their equivalents. Also, various modifications and changes may be made within the scope of the attached claims.

What is claimed is:

1. A method of controlling an air-conditioning system in a motor vehicle, comprising the steps of:
receiving information related to an actual evaporator temperature;
receiving information related to a desired evaporator temperature;
calculating an evaporator temperature error from the actual evaporator temperature and the desired evaporator temperature;
receiving information related to an ambient temperature;
calculating a compressor stroke correction value using the evaporator temperature and the ambient temperature; and
controlling the compressor using the compressor stroke correction value.

2. The method according to claim 1, wherein the compressor stroke correction value is calculated using a proportional-integral control type algorithm.

3. The method according to claim 2, wherein the proportional-integral control algorithm includes a gain parameter and wherein the value of the gain parameter is selected according to the ambient temperature.

4. The method according to claim 3, wherein the gain parameter has a first value when the ambient temperature is below a threshold temperature and wherein the gain parameter has a second value when the ambient temperature is above the threshold temperature and wherein the first value is different from the second value.

5. The method according to claim 2, wherein the proportional-integral control algorithm includes a reset parameter and wherein the value of the reset parameter is selected according to the ambient temperature.

6. The method according to claim 5, wherein the reset parameter has a first value when the ambient temperature is below a threshold temperature and wherein the reset parameter has a second value when the ambient temperature is above the threshold temperature and wherein the first value is different from the second value.

7. A method of controlling an air-conditioning system in a motor vehicle, comprising the steps of:
receiving information related to an actual evaporator temperature;
receiving information related to a desired evaporator temperature;
calculating an evaporator temperature error from the actual evaporator temperature and the desired evaporator temperature;
receiving information related to an ambient temperature;
retrieving a threshold temperature;
calculating a compressor stroke correction value using a control parameter and the evaporator temperature error, the control parameter being associated with a proportional-integral control algorithm; and
wherein the control parameter has a first value when the ambient temperature is above the threshold temperature and wherein the control parameter has a second value when the ambient temperature is below the threshold temperature, the first value being different from the second value.

8. The method according to claim 7, wherein the control parameter is a gain parameter, the gain parameter being associated with a proportional calculation of the proportional-integral control algorithm.

9. The method according to claim 8, wherein the first value is greater than the second value.

10. The method according to claim 7, wherein control parameter is a reset parameter, the reset parameter being associated with an integral calculation of the proportional-integral control algorithm.

11. The method according to claim 10, wherein the first value is less than the second value.

12. The method according to claim 7, wherein the threshold temperature has a value in the range between 20 degrees Celsius and 25 degrees Celsius.

13. The method according to claim 12, wherein the threshold temperature has a value of approximately 22 degrees Celsius.

14. A method of controlling an air-conditioning system in a motor vehicle, comprising the steps of:
receiving information related to an actual evaporator temperature;
receiving information related to a desired evaporator temperature;
calculating an evaporator temperature error from the actual evaporator temperature and the desired evaporator temperature;
receiving information related to an ambient temperature;
retrieving a threshold temperature; and
operating a compressor in a first compressor stroke range when the ambient temperature is above the threshold temperature and operating the compressor in a second compressor stroke range when the ambient temperature is below the threshold temperature, the first compressor stroke range being different from the second compressor stroke range.

15. The method according to claim 14, wherein the first compressor stroke range is a wide compressor stroke range.

16. The method according to claim 15, wherein the second compressor stroke range is a narrow compressor stroke range.

17. The method according to claim 16, wherein the step of operating the compressor in the wide compressor stroke range includes selecting a first value for a gain parameter used in a proportional-integral calculation, the proportional-integral calculation being used to calculate a compressor stroke correction value that is used to control the compressor.

18. The method according to claim 17, wherein the step of operating the compressor in the narrow compressor stroke range includes selecting a second value for the gain parameter, the second value being different from the first value.

19. The method according to claim 16, wherein the step of operating the compressor in the wide compressor stroke range includes selecting a first value for a reset parameter used in a proportional-integral calculation, the proportional-integral calculation being used to calculate a compressor stroke correction value that is used to control the compressor.

20. The method according to claim 19, wherein the step of operating the compressor in the narrow compressor stroke range includes selecting a second value for the reset parameter, the second value being different from the first value.
